(19) United States
(12) Patent Application Publication
(10) Pub. No.: US 2019/0041810 A1
(43) Pub. Date: Feb. 7, 2019

(54) FUZZY ENERGY SAVING CONTROL METHOD FOR MANUFACTURING SYSTEM BASED ON REAL-TIME PRODUCTION DATA

(71) Applicant: Huazhong University of Science and Technology, Wuhan (CN)

(72) Inventors: Junfeng WANG, Wuhan (CN); Jin XUE, Wuhan (CN); Shiqi LI, Wuhan (CN); Yan FU, Wuhan (CN); Zicheng FEI, Wuhan (CN)

(21) Appl. No.: 16/051,888

(22) Filed: Aug. 1, 2018

(30) Foreign Application Priority Data
Aug. 2, 2017 (CN) 2017106532458

(51) Int. Cl. G05B 13/02; G05B 13/04; G06F 1/32

(52) U.S. Cl. CPC G05B 13/0275; G06F 1/3287; G05B 13/047; G05B 13/042

(57) ABSTRACT

The present invention belongs to the field of energy-saving control of manufacturing system and specifically discloses a fuzzy energy saving control method for a manufacturing system based on real-time production data, comprising: (1) obtaining the amount of work-in-process (WIP) in an upstream buffer and the amount of WIP in a downstream buffer of a currently running machine as two input variables for fuzzy reasoning; (2) performing fuzzy reasoning with a fuzzy rule based on the amount of WIP in the upstream buffer and the amount of WIP in the downstream buffer to obtain a fuzzy output value; and (3) comparing the fuzzy output value with a predefined threshold to determine whether the fuzzy output value is less than the threshold or not, if yes, stopping the currently running machine, and if not, keeping the current state. In the present invention, the effective energy consumption control of the manufacturing system can be realized, and this method has the advantages of convenience in operation, high applicability and the like.

### BACKGROUND OF THE PRESENT INVENTION

### Field of the Present Invention

The present invention belongs to the field of energy-saving control of manufacturing system, and more particularly relates to a fuzzy energy saving control method for a manufacturing system based on real-time production data.

### Description of the Related Art

With the widespread application of industrial Internet, RFID, robotics and other sensing and automation equipment in the manufacturing field, the automation degree of the manufacturing system is improved, but how to realize the energy-saving control of these highly automated manufacturing systems is an urgent problem to be solved in the art.

The existing research on the energy consumption of manufacturing systems is mostly based on the research and development of novel low-energy machining equipment, ignoring the control of energy consumption in the level of the overall manufacturing systems. At present, some scholars in the art adopt a transient analysis method to analyze the energy consumption of the production line, and the basic idea of this method is to reduce the duration of the idle state of the machine to improve the energy efficiency of the production line. The other method is to determine the energy and resources consumption of the manufacturing process advanced in the production plan and fully optimize the production process and the process design, thereby achieving the purpose of improving the energy utilization efficiency of the system. However, these energy consumption control methods are all in assigned mode. Due to random factors in the manufacturing system, it is difficult to accurately describe the state of the system by assigned mode, and the machine equipment cannot be controlled in real time according to the system state, thereby missing the energy saving opportunity.

Fuzzy control theory and fuzzy interval algorithm are used to develop distributed and supervised continuous flow control architectures for demand-based production process control, the purpose of which is to keep the system inventory and cycle time at a low level and improve the machine utilization rate and throughput by adjusting the processing speed at each production stage. However, how to use fuzzy control to achieve energy-saving of manufacturing systems is still a difficulty in the art.

### SUMMARY OF THE PRESENT INVENTION

In view of the above-described problems, the present invention provides a fuzzy energy saving control method for a manufacturing system based on real-time production data by combining the characteristics of the manufacturing system itself. A fuzzy energy-saving control method for the manufacturing system is designed accordingly. In this method, the level of the upstream and downstream buffers of the machine is obtained in real time, and then an active energy-saving decision is made base on the obtained information. The decision changes the machine state related with the working energy consumption state of the machine in order to achieve energy-saving production and effective energy consumption control of the manufacturing system. Thus, this method has the advantages of convenient in operation, high applicability and the like.

In order to achieve the above objective, the present invention provides a fuzzy energy saving control method for a manufacturing system based on real-time production data, comprising:

(1) obtaining the amount of work-in-process (WIP) in an upstream buffer and the amount of WIP in a downstream buffer of a currently running machine as two input variables for fuzzy reasoning;

(2) performing fuzzy reasoning with a fuzzy rule based on the amount of WIP in the upstream buffer and the amount of WIP in the downstream buffer to obtain a fuzzy output value; and

(3) comparing the fuzzy output value with a predefined threshold to determine whether the fuzzy output value is less than the threshold or not, if yes, stopping the currently running machine, and if not, keeping the current state.

Preferably, the step (2) specifically comprises the following sub-steps:

(2.1) buffer capacity partition: equally dividing respective capacities of the upstream buffer and the downstream buffer into four intervals, the four intervals containing five equal diversion points which are respectively defined as an empty point, an almost-empty point, a normal point, an almost-full point and a full point;

(2.2) machine state decision: based on the amount of WIP in the upstream buffer and the amount of WIP in the downstream buffer, respectively determining the corresponding points and then determining the machine state (i.e. the ON state or the OFF state) with a fuzzy rule according to the points to which the amount of WIP in the upstream buffer and the amount of WIP in the downstream buffer belong; and

(2.3) fuzzy output value outputting: according to the points to which the amount of WIP in the upstream buffer and the amount of WIP in the downstream buffer belong, respectively calculating membership degrees of the amount of WIP in the upstream buffer and downstream buffer, selecting corresponding membership degrees as output membership degrees according to the machine state, and finally selecting the largest output membership degree as a fuzzy output value.

Preferably, the membership degrees are calculated by a center of gravity method, the specific process comprising:

A) constructing X axis with the capacity of the upstream buffer or the capacity of the downstream buffer, equally dividing the capacity into four intervals, constructing Y axis with the membership degree, and then constructing a plurality of triangles with a height of 1 with the X axis as bases of the triangles;

B) determining an interval at which the amount of WIP in the upstream buffer or the amount of WIP in the downstream buffer is located, namely, determining an interval at which the first input variable or the second input variable is located, obtaining an intersection point of the vertical line passing through the first input variable or the second input variable and the constructed triangle, and then cutting the constructed triangle with the horizontal line passing through the intersection point to obtain a triangle or trapezoid; and

C) calculating the center of gravity of the triangle or trapezoid obtained in the step B) as a membership degree of the first input variable or the second input variable.

Preferably, the method of selecting corresponding membership degrees as output membership degrees according to the machine state comprises: when the machine state is the ON state, selecting the larger membership degree in the membership degrees corresponding to the two input variables as an output membership degree; and when the machine state is the OFF state, selecting the smaller membership degree in the membership degrees corresponding to the two input variables as an output membership degree.

In general, compared with the prior art, the present invention has the following beneficial effects:

(1) in view of the problem that the machine has much idle time due to unstable factors in the manufacturing system which results in the insignificance increase of the system energy consumption, the present invention provides a fuzzy energy-saving control method, in which information in the upstream and downstream buffers of the machine is obtained in real time and then an active energy-saving decision is made base on the obtained information, thereby changing the machine state and then transferring the working energy consumption state of the machine to achieve energy-saving production;

(2) in the present invention, the WIP levels in the two adjacent buffers of the machine are used as input variables and fuzzy reasoning is performed with a fuzzy rule based on the input variables to control the working state of the machine equipment and then the control of the energy consumption, so that the machine equipment has the self-awareness and decision-making ability throughout the system running phase, that is, the running energy consumption can be adjusted in real time according to the internal state, thereby further enriching the process control of the IoT manufacturing system driven by real-time data sensing and data processing, and thus achieving green manufacturing with low energy consumption; and

(3) the fuzzy energy saving control method of the invention has strong robustness and is suitable for the control of a nonlinear system, especially a manufacturing system in which a mathematical model is difficult to establish and dynamic features are difficult to capture; and this method does not require a researcher to establish an accurate mathematical model and can get a good control effect only according to real-time data. A fuzzy controller in the manufacturing system makes the decision according the different real-time levels in the upstream and downstream buffers and switches the energy consumption state of the machine.

### BRIEF DESCRIPTION OF THE DRAWINGS

FIG. 1 is a diagram showing a corresponding relationship between the running state and the energy consumption state of the machine;

FIG. 2 is a diagram showing transition conditions of the running state of the machine;

FIG. 3 is a fuzzy logic control diagram;

FIG. 4 is a diagram showing membership degree of the input variable;

FIG. 5 is a diagram showing membership degree of the output variable;

FIG. 6 is a fuzzy energy-saving control model of a serial unit;

FIG. 7 is a fuzzy energy-saving control model of an assembly unit;

FIG. 8 is a fuzzy energy-saving control model of a disassembly unit;

FIGS. 9 (a) and (b) respectively show the membership degree corresponding to the amount of the work-in-process (WIP) in the upstream buffer and the membership degree corresponding to the amount of WIP in the downstream buffer in Embodiment 1;

FIGS. 10 (a) and (b) respectively show the membership degree corresponding to the amount of the WIP in the upstream buffer and the membership degree corresponding to the amount of WIP in the downstream buffer in Embodiment 2;

FIG. 11 is a diagram showing an example of a serial manufacturing system composed of serial units;

FIG. 12 is a diagram showing the state distribution of the machine M1;

FIG. 13 is a diagram showing the level change in the buffer B1 (without control);

FIG. 14 is a diagram showing the level change in the buffer B1 (with control); and

FIG. 15 is a flowchart of a fuzzy energy saving control method for a manufacturing system based on real-time production data.

### DETAILED DESCRIPTION OF THE EMBODIMENTS

For clear understanding of the objectives, features and advantages of the present invention, detailed description of the present invention will be given below in conjunction with accompanying drawings and specific embodiments. It should be noted that the embodiments described herein are only meant to explain the present invention, and not to limit the scope of the present invention.

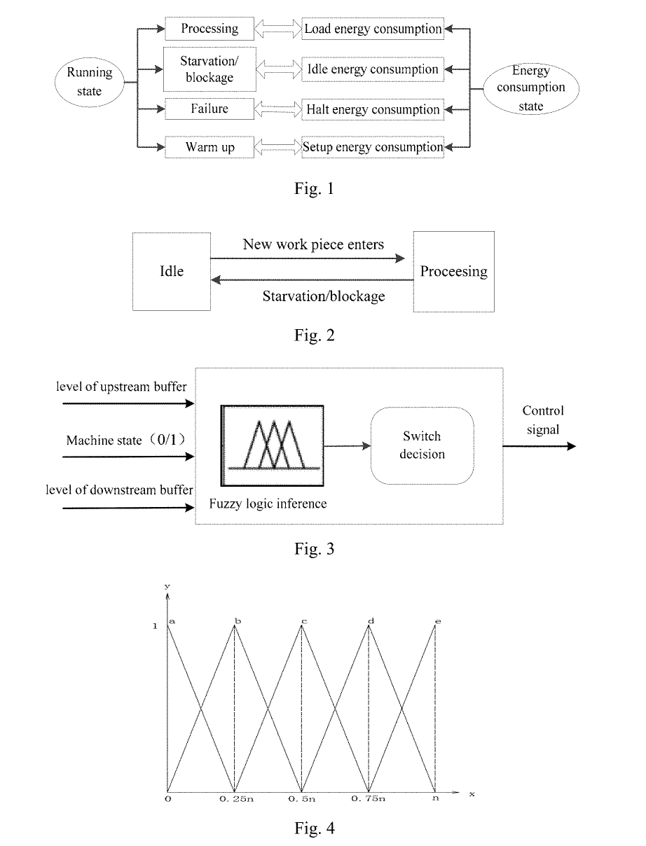

During the running process of the manufacturing system, the running state and the energy consumption state of the machine correspond to each other, and different running states correspond to different energy consumption states. During the system operation, the machine has multiple running states, and the transition of these states may cause the power change in the device, thereby resulting in the change in the energy consumption of the machine, as shown in FIG. 1. Thus, the analysis of the energy consumption of the machine can be converted into the analysis of the running state of the machine. The running state of the machine can be divided into four types: shutdown, warm-up, on-load processing and no-load idle running. At the beginning of the processing shift, the machine is in a shutdown state. After the startup, the parts enter the machine, and the machine is officially transferred into an on-load processing state to start the processing of the part. When no part enters the machine, the machine goes into a no-load idle running state. When the downstream buffer is full so that the finished part cannot be transferred downstream, the machine will also be in a no-load idle running state, as shown in FIG. 2.

In the present invention, by virtue of the sensors in the production site, level information in the buffers is obtained and shared in real time at discrete time points. A fuzzy logic controller is provided for the machine to process data information collected by the sensors in the production site so as to evaluate the state of the manufacturing system with the real-time data and make a decision (as shown in FIG. 3). For a serial production line with m machines and m−1 buffers, the current machine state and the WIP levels in the adjacent upstream and downstream buffers are monitored. The information is fed back to the controller in real time and fuzzy inference is performed through a predefined fuzzy rule to obtain a fuzzy output value, which controls the next state of the current machine.

Specifically, as shown in FIG. 15, a fuzzy energy saving control method for a manufacturing system based on real-time production data is provided according to an embodiment of the present invention, the method comprising:

(1) obtaining the amount of WIP in the upstream buffer (i.e., WIP level Bᵢ₋₁ in the upstream buffer) and the amount of WIP in the downstream buffer (i.e., WIP level Bᵢ in the downstream buffer) of a currently running machine Mᵢ (i is a positive integer, for example, M₁ represents the first machine and M₂ represents the second machine), and using these two data as two input variables for fuzzy reasoning;

(2) based on the two input variables (i.e., the amount of WIP in the upstream buffer and the amount of WIP in the downstream buffer), performing fuzzy reasoning with a fuzzy rule to obtain a fuzzy output value;

(3) comparing the fuzzy output value with a predefined threshold to determine whether the fuzzy output value is less than the threshold or not, if yes, stopping the currently running machine, and if not, keeping the currently running machine in the current state.

In actual operation, the above steps in the present invention can be implemented by adding sensors and fuzzy controllers to the manufacturing system so as to achieve energy-saving control of the machine.

Specifically, the step (2) comprises the following sub-steps:

(2.1) buffer capacity partition: equally dividing respective capacities n of the upstream buffer and the downstream buffer into four intervals, as shown in FIG. 4, the four intervals containing five points which are respectively defined as an empty point 0 (point a in FIG. 4), an almost-empty point 0.25n (point b in FIG. 4), a normal point 0.5n (point c in FIG. 4), an almost-full point 0.75n (point d in FIG. 4) and a full point n (point e in FIG. 4).

(2.2) machine state decision: based on the amount of WIP in the upstream buffer and the amount of WIP in the downstream buffer, respectively determining points to which they belong, and according to the points to which the amount of WIP in the upstream buffer and the amount of WIP in the downstream buffer belong, determining the machine state with a fuzzy rule, the machine state including an ON state and an OFF state. Specifically, when the amount of WIP is equal to a value of one of the above five points, the corresponding point is the point to which the amount of WIP belongs; when the amount of WIP is between values of two adjacent points, it can be belong to the two adjacent points, respectively. For example, if the amount of WIP in the upstream buffer is 0.1n which is in the interval [0, 0.25n], it belongs to the empty point and the almost-empty point; and if the amount of WIP in the downstream buffer is 0.6n which is in the interval [0.5n, 0.75n], it belongs to the normal point and the almost-full point. In this case, four judgments are required with the fuzzy rule, i.e., judging the machine state in the following four cases: the amount of WIP in the upstream buffer belongs to the empty point and the amount of WIP in the downstream buffer belongs to the normal point; the amount of WIP in the upstream buffer belongs to the empty point and the amount of WIP in the downstream buffer belongs to the almost-full point; the amount of WIP in the upstream buffer belongs to the almost-empty point and the amount of WIP in the downstream buffer belongs to the normal point; and the amount of WIP in the upstream buffer belongs to the almost-empty point and the amount of WIP in the downstream buffer belongs to the almost-full point.

(2.3) fuzzy output value outputing: according to the points to which the amount of WIP in the upstream buffer and the amount of WIP in the downstream buffer belong, respectively calculating membership degrees corresponding to the amount of WIP in the upstream buffer and the amount of WIP in the downstream buffer, selecting corresponding membership degrees as output membership degrees according to the machine state, and finally selecting the largest output membership degree as a fuzzy output value with a value range of [0, 1]. For example, in the step (2.2), four judgments are performed, each judgment corresponds to one output membership degree, and finally the largest output membership degree among the four output membership degrees is selected as the fuzzy output value.

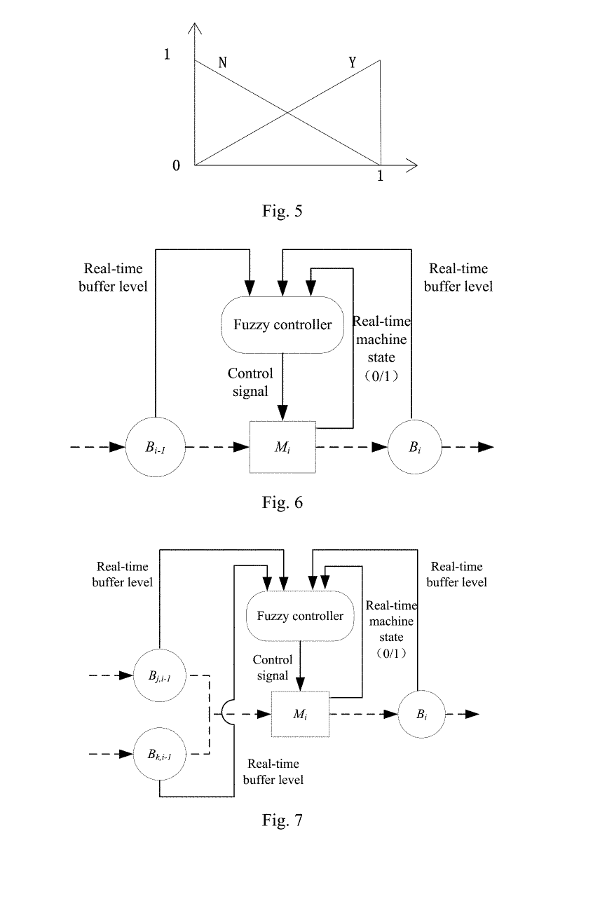

The step (2) is the core of the fuzzy control method of the present invention, in which the real-time WIP level in the buffers of the manufacturing process is described by membership degree functions. The WIP levels (i.e., the amount of WIP) in the upstream and downstream buffers are used as input values. Two fuzzy sets (i.e., two states of the machine) are determined by a fuzzy rule, as shown in FIG. 5, the two states are respectively called “ON” (represented by N), “OFF” (represented by Y). Corresponding membership degrees are calculated according to the two input values. Finally, a fuzzy output value is obtained by combining the membership degrees with the fuzzy sets.

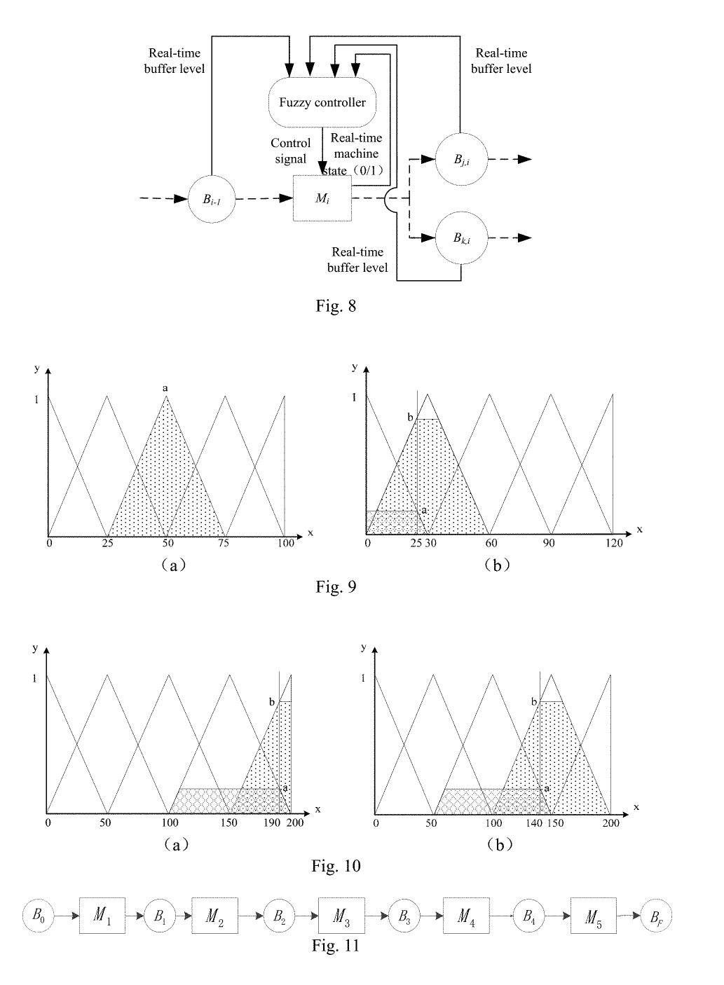

Further, the fuzzy rules are obtained based on expert knowledge, and are related to the type of the production line of the manufacturing system. Generally, in the production line of the manufacturing system, a serial unit (FIG. 6) and/or an assembly unit (FIG. 7) and/or a disassembly unit (FIG. 8) are provided according to production requirements. Complex types of the manufacturing system can be formed by a combination of the three kinds of units.

A fuzzy rule is provided for each production unit. Specifically, as shown in Table 1-Table 3, for an assembly unit which has multiple upstream WIP levels and a disassembly unit which has multiple downstream WIP levels, each upstream WIP level or downstream WIP level is required to be judged.

TABLE 1
a fuzzy rule of a serial unit

| | upstream | | | | |
|---|---|---|---|---|---|
| downstream state | empty | almost-empty | normal | almost-full | full |
| empty | N | N | Y | Y | Y |
| almost-empty | N | N | Y | Y | Y |
| normal | N | N | Y | Y | Y |
| almost-full | N | N | N | N | N |
| full | N | N | N | N | N |

TABLE 2
a fuzzy rule of an assembly unit

| downstream j | upstream | | | | |
|---|---|---|---|---|---|
| downstream k state | empty | almost-empty | normal | almost-full | full |
| empty | N | N | Y | Y | Y |
| almost-empty | N | N | Y | Y | Y |
| normal | N | N | Y | Y | Y |
| almost-full | N | N | N | N | N |
| full | N | N | N | N | N |

TABLE 3
a fuzzy rule of a disassembly unit

| upstream k | upstream j | | | | |
|---|---|---|---|---|---|
| downstream state | empty | almost-empty | normal | almost-full | full |
| empty | N | N | Y | Y | Y |
| almost-empty | N | N | Y | Y | Y |
| normal | N | N | Y | Y | Y |
| almost-full | N | N | N | N | N |
| full | N | N | N | N | N |

The membership degree refers to the degree to which the input value belongs to a fuzzy set. The higher the membership degree, the higher the degree to which the input value belongs to the fuzzy set. The membership degree has a maximum value of 1, and when values of two input variables Bᵢ₋₁ and Bᵢ are input, the controller performs fuzzy reasoning on the input values with the fuzzy rule to obtain membership degrees corresponding to the two input variables.

In the present invention, a center of gravity method is preferably adopted for calculation. As shown in FIG. 4, a horizontal ordinate (i.e., the X axis) is first constructed with the capacity n of the upstream or downstream buffer, and the capacity is equally divided into four intervals including five points. The empty point is used as the coordinate origin. Then, a vertical ordinate (i.e., the Y axis) is constructed with the membership degree, and the membership degree has a maximum value of 1 in the Y axis. Finally, a plurality of triangles with a height of 1 are constructed with the X axis as the bases of the triangles (namely, membership degree functions are established). Specifically, as shown FIG. 4, these triangles are: isosceles triangles with a height of 1 which are respectively constructed with intervals [0, 0.5n], [0.25n, 0.75n], [0.5n, n] as the bases; a right-angled triangle with a height of 1 which is constructed with an interval [0, 0.25n] as a right-angled edge and the Y axis as the other right-angled edge; and a right-angled triangle with a height of 1 which is constructed with an interval [0.75n, n] as a right-angled edge and the vertical line passing through the point n as the other right-angled edge. The membership degree functions corresponding to different zones are specifically shown in Table 4. Then, the interval at which the amount of WIP in the upstream buffer or the amount of WIP in the downstream buffer is located is determined, namely, the interval at which the first input variable or the second input variable is located is determined, and then an intersection point of the vertical line passing through the first input variable or the second input variable and the constructed triangle is obtained. Subsequently, the constructed triangle is cut by the horizontal line passing through the intersection point to obtain a triangle or trapezoid below the horizontal line. Specifically, when the value of the input variable is equal to the point value of a certain point, a triangle is obtained after the cutting, and when the value of the input variable is between two adjacent points, two trapezoids inside the two corresponding constructed triangles are obtained after the cutting.

Subsequently, the center of gravity of the triangle or trapezoid is calculated as a membership degree of the first input variable or the second input variable. Taking one of the input variables as an example, when the value of the input variable is equal to the value of a certain point, the vertical line passing through the point value intersects the vertex of the constructed triangle and in this case, the center of gravity of the triangle can be calculated as the membership degree of the input variable; when the value of the input variable is between two adjacent points, the vertical line passing through the input variable may intersects one side of each of two triangles to obtain two trapezoids, and in this case, center of gravities of the trapezoids are respectively calculated as membership degrees of the input variable, that is, the input variable may has two membership degrees.

TABLE 4
type and parameter of the membership degree function

| | | Membership degree function | |
|---|---|---|---|
| | | Type | Parameter |
| Upstream | empty | right angled triangle | [0 0 0.25n] |
| buffer | almost-empty | isosceles triangle | [0 0.25n 0.5n] |
| | normal | isosceles triangle | [0.25n 0.5n 0.75n] |
| | almost-full | isosceles triangle | [0.5n 0.75n n] |
| | full | right angled triangle | [0.75n n n] |
| Downstream | empty | right angled triangle | [0 0 0.25n] |
| buffer | almost-empty | isosceles triangle | [0 0.25n 0.5n] |
| | normal | isosceles triangle | [0.25n 0.5n 0.75n] |
| | almost-full | isosceles triangle | [0.5n 0.75n n] |
| | full | right angled triangle | [0.75n n n] |

In the present invention, the method of selecting corresponding membership degrees as output membership degrees according to the machine state comprises: if the machine is in an ON state, that is, the output fuzzy set corresponding to the rule is N, the larger membership degree in the membership degrees corresponding to the two input variables is selected as an output membership degree; and if the machine is in an OFF state, that is, the output fuzzy set corresponding to the rule is Y, the smaller membership degree in the membership degrees corresponding to the two input variables is selected as an output membership degree. Since the same input variables may correspond to multiple output fuzzy sets, i.e., corresponding to multiple output membership degrees, the largest output membership degree is finally used as a fuzzy output value.

After obtaining the fuzzy output value, it is necessary to determine whether the value reaches the criterion for changing the machine state. Thus, it is necessary to provide a decision threshold (i.e., a predefined threshold), so that when the fuzzy output value reaches a certain value, the criterion for changing the machine state is met, thereby achieving the control of the machine state. Specifically, when the fuzzy output value is less than the decision threshold, it tends to halt the machine and deliver stop information to the control system for the machine server; otherwise, the machine is not controlled.

The selection of the decision threshold value may have an impact on the throughput. The larger threshold means the larger control range, that is, the fuzzy control strength may be enhanced and the current machine throughput loss may be increased. In the present invention, energy consumption is controlled under the premise of minimizing the influence on the machine throughput. In order to reduce the impact on the machine throughput as much as possible, the choice of the threshold value cannot be too large. The smaller threshold value may result in the decrease of the fuzzy control strength and weakening of the energy consumption control of the current machine. Therefore, it is necessary to strike a balance between the machine throughput and the energy consumption control effect by optimizing the throughput and energy consumption based on an appropriate threshold. In general, multiple simulations can be carried out to control the machine throughput loss to be within 5% by the exhaustive method, and in this case, by comparing the machine throughput corresponding to different thresholds and the energy consumption value of a single product, an appropriate threshold of the controller is determined. The specific threshold can be defined according to the actual needs, and the invention is not limited thereto.

The following is an exemplary description of the fuzzy rules of the present invention.

### Embodiment 1

This embodiment takes a serial unit as an example, in which the capacity of WIP in the upstream buffer is 100, and the capacity of WIP in the downstream buffer is 120. The specific method comprises:

(1) obtaining the amount of WIP of 50 in the upstream buffer and the amount of WIP of 25 in the downstream buffer in the currently running machine M₃ based on sensors, and transmitting them to a fuzzy controller;

(2) based on the real-time data from the sensors, performing fuzzy reasoning with a fuzzy rule by the fuzzy controller to obtain a fuzzy output value. The specific process is as follows: an upstream buffer coordinate system and a downstream buffer coordinate system are respectively established; in the upstream buffer coordinate system, the X axis has a maximum value of 100 and is divided into four intervals including five points, the Y axis has a maximum value of 1 and the five points are respectively an empty point 0, an almost-empty point 25, a normal point 50, an almost-full point 75 and a full point 100. In the downstream buffer coordinate system, the X axis has a maximum value of 120 and is divided into four intervals including five points, the Y axis has a maximum value of 1 and the five points are respectively an empty point 0, an almost-empty point 30, a normal point 60, an almost-full point 90 and a full point 120. It is known that the amount of WIP of 50 in the upstream buffer belongs to the normal point and the amount of WIP of 25 in the downstream buffer belongs to the empty point and the almost-empty point, and then two judgments are required according to the fuzzy rule (see Table 1), the reasoning result being “Y”. According to the amount of WIP of 50 in the upstream buffer, the corresponding membership degree “A” is calculated in the following way. As shown in FIG. 9(a), an intersection point “a” of the vertical line passing through the point 50 and the constructed triangle is obtained. Then the constructed triangle is cut by the horizontal line passing through the intersection point “a” to obtain a triangle below the horizontal line. Finally the center of gravity of the triangle is calculated, that is, the center of gravity of the triangle with a height of 1 which is constructed with the interval [25, 75] as the base is calculated. According to the amount of WIP of 25 in the downstream buffer, the corresponding membership degree is calculated in the following way: as shown in FIG. 9(b), two intersection points “a” and “b” of the vertical line passing through the point 25 and the constructed triangles are obtained. Then the constructed triangles are respectively cut by the horizontal lines passing through the intersection points “a” and “b” to obtain two trapezoids (i.e., a big trapezoid and a small trapezoid as shown by shaded areas in FIG. 9(b)) below the horizontal lines, and finally the center of gravities of the big trapezoid and the small trapezoid are respectively calculated as two membership degrees (i.e., a membership degree “B” for the big trapezoid and a membership degree “C” for the small trapezoid) corresponding to the amount of WIP in the downstream buffer. Then the fuzzy output value is selected in the following way: if the amount of WIP in the upstream buffer belongs to the normal point and the amount of WIP in the downstream buffer belongs to the empty point, the reasoning result is “Y” and the smaller one of the two membership degrees “A” and “C” is used as an output membership degree. If the amount of WIP in the upstream buffer belongs to the normal point and the amount of WIP in the downstream buffer belongs to the almost-empty point, the reasoning result is “Y” and the smaller one of the two membership degrees “A” and “B” is used as an output membership degree. Finally the larger one of the two output membership degrees is selected as a fuzzy output value; and

(3) comparing the fuzzy output value with a predefined threshold (which is defined according to actual needs) by the fuzzy controller to determine whether the fuzzy output value is less than the threshold or not, if yes, sending a stop control command to stop the currently running machine, and if not, keeping the currently running machine in the current state, namely, keeping the currently machine running without stopping.

### Embodiment 2

This embodiment takes a serial unit as an example, in which capacity of WIP in the upstream buffer is 200, and the capacity of WIP in the downstream buffer is 200. The specific method comprises:

(1) obtaining the amount of WIP of 190 in the upstream buffer and the amount of WIP of 140 in the downstream buffer in the currently running machine M₈ by sensors, and transmitting them to a fuzzy controller;

(2) based on the real-time data from the sensors, performing fuzzy reasoning with a fuzzy rule by the fuzzy controller to obtain a fuzzy output value. The specific process is as follows: respectively establishing an upstream buffer coordinate system and a downstream buffer coordinate system, in which in the upstream buffer coordinate system, the X axis has a maximum value of 200 and is divided into four intervals including five points, the Y axis has a maximum value of 1 and the five points are respectively an empty point 0, an almost-empty point 50, a normal point 100, an almost-full point 150 and a full point 200. In the downstream buffer coordinate system, the X axis has a maximum value of 200 and is divided into four intervals including five points, the Y axis has a maximum value of 1 and the five points are respectively an empty point 0, an almost-empty point 50, a normal point 100, an almost-full point 150 and a full point 200. It is known that the amount of WIP of 190 in the upstream buffer belongs to the almost-full point and the full point. The amount of WIP of 140 in the downstream buffer belongs to the normal point and the almost-full point. Then the following four judgments are required according to the fuzzy rule (see Table 1): if the amount of WIP in the upstream buffer belongs to the almost-full point and the amount of WIP in the downstream buffer belongs to the normal point, the reasoning result is “Y”; if the amount of WIP in the upstream buffer belongs to the near-full point and the amount of WIP in the downstream buffer belongs to the almost-full point, the reasoning result is “N”; if the amount of WIP in the upstream buffer belongs to the full point and the amount of WIP in the downstream buffer belongs to the normal point, the reasoning result is “Y”; and if the amount of WIP in the upstream buffer belongs to the full point and the amount of WIP in the downstream buffer belongs to the almost-full point, the reasoning result is “N”; according to the amount of WIP of 190 in the upstream buffer, the corresponding membership degrees are calculated in the following way: as shown in FIG. 10(a), two intersection points “a” and “b” of the vertical line passing through the point 190 and the constructed triangles are obtained, then the constructed triangles are respectively cut by the horizontal lines passing through the intersection points “a” and “b” to obtain two trapezoids (i.e., a big trapezoid and a small trapezoid as shown by shaded areas in FIG. 10(a)) below the horizontal lines, and finally the center of gravities of the big trapezoid and the small trapezoid are respectively calculated as two membership degrees (i.e., a membership degree “A” for the big trapezoid and a membership degree “B” for the small trapezoid) corresponding to the amount of WIP in the upstream buffer; according to the amount of WIP of 140 in the downstream buffer, the corresponding membership degrees are calculated in the following way: as shown in FIG. 10(b), two intersection points “a” and “b” of the vertical line passing through the point 140 and the constructed triangles are obtained, then the constructed triangles are respectively cut by the horizontal lines passing through the intersection points “a” and “b” to obtain two trapezoids (i.e., a big trapezoid and a small trapezoid as shown by shaded areas in FIG. 10(b)) below the horizontal lines, and finally the center of gravities of the big trapezoid and the small trapezoid are respectively calculated to obtain two membership degrees (i.e., a membership degree “C” for the big trapezoid and a membership degree “D” for the small trapezoid) corresponding to the amount of WIP in the downstream buffer; and then the fuzzy output value is selected in the following way: if the amount of WIP in the upstream buffer belongs to the almost-full point (the corresponding membership degree is “B”) and the amount of WIP in the downstream buffer belongs to the normal point (the corresponding membership degree is “D”), the reasoning result is “Y” and the smaller one of the two membership degrees “B” and “D” is used as an output membership degree; if the amount of WIP in the upstream buffer belongs to the almost-full point (the corresponding membership degree is “B”) and the amount of WIP in the downstream buffer belongs to the almost-full point (the corresponding membership degree is “C”), the reasoning result is “N” and the larger one of the two membership degrees “B” and “C” is used as an output membership degree; if the amount of WIP in the upstream buffer belongs to the full point (the corresponding membership degree is “A”) and the amount of WIP in the downstream buffer belongs to the normal point (the corresponding membership degree is “D”), the reasoning result is “Y” and the smaller one of the two membership degrees “A” and “D” is used as an output membership degree; and if the amount of WIP in the upstream buffer belongs to the full point (the corresponding membership degree is “A”) and the amount of WIP in the downstream buffer belongs to the almost-full point (the corresponding membership degree is “C”), the reasoning result is “N” and the larger one of the two membership degrees “A” and “C” is used as an output membership degree; and finally the largest one among the four output membership degrees is selected as a fuzzy output value; and

(3) comparing the fuzzy output value with a predefined threshold (which is defined according to actual needs) by the fuzzy controller to determine whether the fuzzy output value is less than the threshold or not, if yes, sending a stop control command to stop the currently running machine, and if not, keeping the currently running machine in the current state, namely, keeping the currently machine running without stopping.

The following are specific application examples of the present invention.

In the MATLAB/Simulink simulation environment, a manufacturing system model is built using the Fuzzy Logic Toolbox and the Simevents Toolbox, in which the production line system is decomposed into basic control units, and a fuzzy controller is provided for each control unit so that the total energy consumption of the system is greatly reduced under the premise of an acceptable system throughput of 5-10%. The simulations proved that the production line structure applicable to the invention includes a serial production line and different types of serial-parallel hybrid production lines.

By taking a 5M4B serial manufacturing system as an example (FIG. 11), control analysis is carried out, and the production line system parameters are shown in Table 5 and Table 6. The production shift is 8 hours per day and the number of times of simulations is 50.

TABLE 5
basic parameters of machines of the 5M4B serial line

| | | | Processing | Warm-up | Energy |
|---|---|---|---|---|---|
| | MTBF | MTTR | cycle | time | consumption |
| | (min) | (min) | (min) | (min) | (kw/h) |
| M1 | 100 | 4.95 | 0.5 | 1.4 | 21 |
| M2 | 45.6 | 11.7 | 0.5 | 0.9 | 14 |
| M3 | 98.8 | 15.97 | 0.5 | 1.35 | 20 |
| M4 | 217.5 | 27.28 | 0.5 | 1.05 | 16 |
| M5 | 109.4 | 18.37 | 0.5 | 0.85 | 13 |

TABLE 6
parameters of buffers of the 5M4B serial line

| | Buffer1 | Buffer2 | Buffer3 | Buffer4 |
|---|---|---|---|---|
| Capacity | 70 | 18 | 18 | 42 |
| Initial value | 32 | 8 | 8 | 8 |

(1) A Case where the System is not Controlled

The simulation results are shown in Tables 7 and 8. According to the analysis in Table 6, during the operation of the 5M4B serial manufacturing system, the machines M1 and M2 are in a blocked state for a long time and the machines M4 and M5 are in a starvation state for a long time. According to the judgment of the bottleneck station, it can be known that the bottleneck of the production line is the machine M3, and each machine in the manufacturing system has a long-time no-load running state, and thus has a large energy-saving potential.

TABLE 7
throughputs of machines of the uncontrolled 5M4B serial line

| | | Throughout | Energy consumption |
|---|---|---|---|
| Machine | 95% confidence interval | (average) | (kWh) |
| M1 | (579.28, 673.81) | 626 | 138.66 |
| M2 | (553.76, 623.79) | 588 | 78.01 |
| M3 | (560.78, 620.86) | 590 | 120.71 |
| M4 | (552.29, 632.48) | 592 | 95.78 |
| M5 | (558.44, 620.49) | 589 | 76.54 |

TABLE 8
states of machines of the uncontrolled 5M4B serial line

| | | | | | Fault | warm-up | processing |
|---|---|---|---|---|---|---|---|
| | Starvation | Ratio | Block | Ratio | time | time | time |
| | (s) | (%) | (s) | (%) | (s) | (s) | (s) |
| M1 | 0 | 0 | 6972 | 24.21 | 2376 | 672 | 18780 |
| M2 | 0 | 0 | 2844 | 5.917 | 7722 | 594 | 17640 |
| M3 | 3260 | 11.31 | 2644 | 9.181 | 4791 | 405 | 17700 |
| M4 | 5865 | 20.36 | 76 | 0.264 | 4910 | 189 | 17700 |
| M5 | 5364 | 18.62 | 0 | 0 | 5511 | 255 | 17670 |

(2) A Case where a Controller is Provided for the Machine M1 (Namely, the System is Controlled According to the Present Invention)

In the control of the manufacturing system, a fuzzy controller is provided for each machine. For the purpose of research and analysis, in the present invention, a single machine is selected for control analysis. When the machine M1 is controlled based on the fuzzy method, the running effect of the manufacturing system is as shown in Table 9 below. It can be obtained that the throughput of the machine M1 is reduced, but it does not affect the throughput of the entire manufacturing system, i.e., the throughput of the machine M5. Compared with the uncontrolled situation, the energy consumption of the machine M1 has dropped by 17.32%.

TABLE 9
change in throughput and energy consumption of the serial line when M1 is controlled

| | | | | | Energy | |
|---|---|---|---|---|---|---|
| | | | Throughout | Energy | consumption | Control |
| | 95% confidence | Throughout | change | Consumption | change | time |
| Machine | interval | (average) | (%) | (Kwh) | (%) | (s) |
| M1 | (569.37, 659.48) | 614 | −1.92% | 113.92 | −17.32% | 10200 |
| M2 | (501.49, 630.14) | 588 | 0 | 78.01 | 0 | 0 |
| M3 | (496.06, 630.75) | 590 | 0 | 120.71 | 0 | 0 |
| M4 | (501.46, 638.42) | 592 | 0 | 95.78 | 0 | 0 |
| M5 | (520.16, 640.19) | 589 | 0 | 76.54 | 0 | 0 |

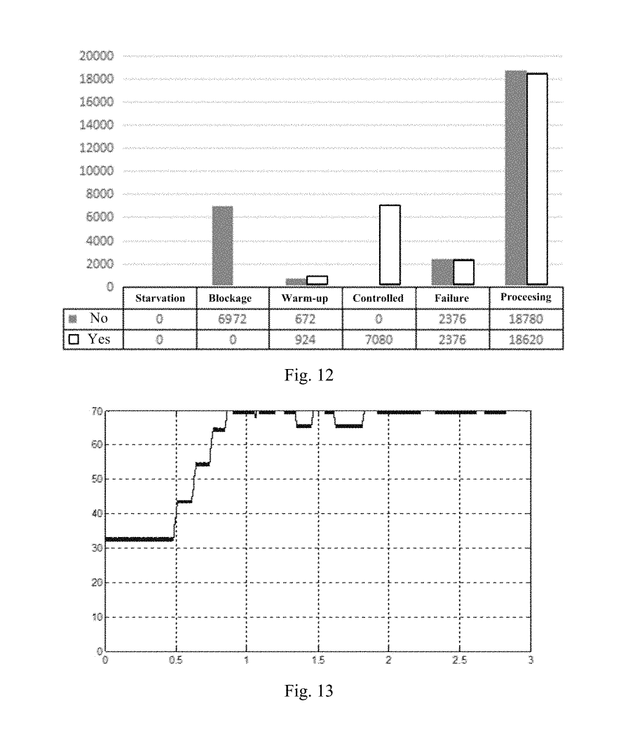

It can be seen from FIG. 12 that after a controller is provided for the machine M1, the blocked state is completely eliminated, and the total control time of the machine M1 is 7080 s, which is the total time for the forced no-load running of the machine due to the blockage.

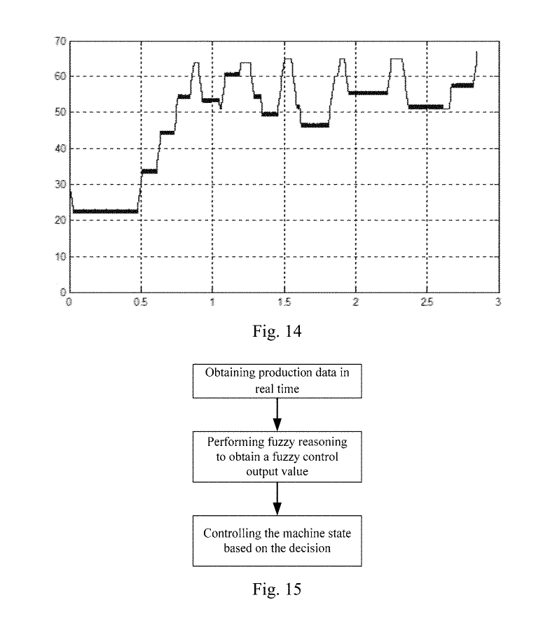

Before and after the control, the change of the WIP level in the buffer B1 is as shown in FIG. 13 and FIG. 14. Before the control, B1 is always full, and thus, the machine M1 is in a blocked state for a long time. In a case where a controller is provided for the machine M1, when the buffer B1 tends to be full, the machine M1 is controlled to stop through the real-time monitoring of the buffer and the real-time processing of the data. When the amount of WIP in the buffer B1 decreases due to continuous consumption, the machine M1 is turned on again. Therefore, the buffer B1 will never be full in the fuzzy control scenario, the usage rate of the buffer is about 80%, and the upstream machine M1 is unblocked.

It can be seen from the analysis in Table 8 that there is no change in the operating state of the machines M2, M3, M4, and M5 before and after the control of the machine M1. Therefore, the difference in energy consumption of the entire manufacturing system before and after the control results from the machine M1, and other uncontrolled machines have no change in energy consumption. According to the state distribution of the respective machines under the condition of no control, the remaining machines on the production line are controlled separately, and the system energy consumptions before and after the control are compared. It can be found that the no-load running times of the controlled machines drop dramatically in a case that the total throughput of the production line is basically unchanged, resulting in the decrease of the energy consumption of the controlled machines.

(3) Multi-Machine Energy-Saving Control

A controller is provided for each machine station except the bottleneck machine M3 in a simulation model, and simulation is performed for 50 times to obtain the mean value. Table 10 shows running states of the system when four machines are controlled at the same time. According to the energy consumption change of each machine before and after the control, it can be obtained that the throughput loss of the serial manufacturing system is about 3.23% and the overall energy consumption is reduced by 11.83%. The throughput loss of the system mainly results from the end station, i.e., the machine M5. That is, the throughput loss of the machine M5 is equal to the throughput loss of the system. As for the decline of the system energy consumption, the specific data is obtained by making statistics of the energy consumption change of each machine before and after the control in the production line and the comparison of energy consumptions before and after the control in the production line.

TABLE 10
change in throughput and energy consumption of the
serial line when multiple machines are controlled

| | | | | | Energy | |
|---|---|---|---|---|---|---|
| | | | Throughout | Energy | consumption | Control |
| | 95% confidence | Throughout | change | Consumption | change | time |
| Machine | interval | (average) | (%) | (Kwh) | (%) | (s) |
| M1 | (564.27, 650.41) | 613 | −2.077 | 113.16 | −18.39 | 10178 |
| M2 | (517.44, 620.48) | 583 | −0.851 | 71.80 | −7.96 | 0 |
| M3 | (491.17, 610.95) | 585 | −1.017 | 120.38 | −0.27 | 7542 |
| M4 | (516.06, 627.26) | 583 | −1.520 | 80.09 | −16.38 | 8331 |
| M5 | (524.76, 648.27) | 570 | −3.226 | 63.96 | −16.44 | 9874 |

The results show that by the fuzzy control of the machine, the WIP level in the buffer between two machines can be maintained at a stable state to ensure the balance of the production line. In this way, the no-load running time of the respective machine can be reduced under the premise of basically unchanged system throughput, thereby achieving the purpose of energy consumption reduction of the production line.

While particular embodiments of the present invention have been shown and described, it will be obvious to those skilled in the art that changes and modifications may be made without departing from the spirit and scope of the present invention.

The present invention claimed is:

1. A fuzzy energy saving control method for a manufacturing system based on real-time production data, comprising:
(1) obtaining the amount of work-in-process (WIP) in an upstream buffer and the amount of WIP in a downstream buffer of a currently running machine as two input variables for fuzzy reasoning;
(2) performing fuzzy reasoning with a fuzzy rule based on the amount of WIP in the upstream buffer and the amount of WIP in the downstream buffer to obtain a fuzzy output value; and
(3) comparing the fuzzy output value with a predefined threshold to determine whether the fuzzy output value is less than the threshold or not, if yes, stopping the currently running machine, and if not, keeping the current state.

2. The fuzzy energy saving control method for the manufacturing system based on real-time production data of claim 1, wherein the step (2) specifically comprises the following sub-steps:
(2.1) buffer capacity partition: equally dividing respective capacities of the upstream buffer and the downstream buffer into four intervals, the four intervals containing five equal diversion points which are respectively defined as an empty point, an almost-empty point, a normal point, an almost-full point and a full point;
(2.2) machine state decision: based on the amount of WIP in the upstream buffer and the amount of WIP in the downstream buffer, respectively determining points to which they belong, and determining the machine state with a fuzzy rule according to the points to which the amount of WIP in the upstream buffer and the amount of WIP in the downstream buffer belong, the machine state including an ON state and an OFF state; and
(2.3) fuzzy output value outputting: according to the points to which the amount of WIP in the upstream buffer and the amount of WIP in the downstream buffer belong, respectively calculating a membership degree or membership degrees corresponding to the amount of WIP in the upstream buffer and a membership degree or membership degrees corresponding to the amount of WIP in the downstream buffer, selecting corresponding membership degrees as output membership degrees according to the machine state, and finally selecting the largest output membership degree as a fuzzy output value.

3. The fuzzy energy saving control method for the manufacturing system based on real-time production data of claim 2, wherein the membership degrees are calculated by a center of gravity method, the specific process comprising:
A) constructing X axis with the capacity of the upstream buffer or the capacity of the downstream buffer, equally dividing the capacity into four intervals, constructing Y axis with the membership degree, and then constructing a plurality of triangles with a height of 1 with the X axis as bases of the triangles;
B) determining an interval at which the amount of WIP in the upstream buffer or the amount of WIP in the downstream buffer is located, namely, determining an interval at which the first input variable or the second input variable is located, obtaining an intersection point of the vertical line passing through the first input variable or the second input variable and the constructed triangle, and then cutting the constructed triangle with the horizontal line passing through the intersection point to obtain a triangle or trapezoid; and
C) calculating the center of gravity of the triangle or trapezoid obtained in the step B) as a membership degree of the first input variable or the second input variable.

4. The fuzzy energy saving control method for the manufacturing system based on real-time production data of claim 2, wherein the method of selecting corresponding membership degrees as output membership degrees according to the machine state comprises: when the machine state is the ON state, selecting the larger membership degree in the membership degrees corresponding to the two input variables as an output membership degree; and when the machine state is the OFF state, selecting the smaller membership degree in the membership degrees corresponding to the two input variables as an output membership degree.
